(19) United States
(12) Patent Application Publication
(10) Pub. No.: US 2024/0413925 A1
(43) Pub. Date: Dec. 12, 2024

(54) CONTROLLING COMMUNICATION SETTINGS AT RADIO LINK ARRANGEMENTS

(71) Applicant: Telefonaktiebolaget LM Ericsson (publ), Stockholm (SE)

(72) Inventors: Martin SJÖDIN, Göteborg (SE); Patrik OLESEN, Floda (SE); Jonas HANSRYD, Göteborg (SE)

(21) Appl. No.: 18/700,876

(22) PCT Filed: Oct. 14, 2021
(86) PCT No.: PCT/EP2021/078399

§ 371 Date: Apr. 12, 2024

(51) Int. Cl. H04L 1/00; H04W 72/543

(52) U.S. Cl. CPC H04L 1/0003; H04L 1/0021; H04W 72/543

(57) ABSTRACT

The present disclosure relates to a control unit arrangement (130, 630) adapted to control at least one communication setting between link nodes in a radio link arrangement (100) comprising at least two link nodes (110, 120) that are adapted to communicate with each other via a time-dependent signal (S) by means of the communication setting. For each time slot, the time-dependent signal (S) is associated with at least a time-dependent communication quality (X(t)), and an identified transmission condition (C1, C2). The control unit arrangement (130, 630) comprising at least one adapting unit (740) configured to adapt at least one threshold condition (X1, X2) for switching from an original communication setting (Y1) to an updated communication setting (Y2) in dependence of an identified current transmission condition (C2), such that each of the at least one threshold condition is changed from a first threshold condition (X1) to a second threshold condition (X2).

### TECHNICAL FIELD

The present disclosure relates to controlling at least one communication setting between link nodes in a radio link arrangement comprising at least two link nodes that are adapted to communicate with each other via a time-dependent signal by means of the communication setting.

### BACKGROUND

Microwave links are an essential part of many telecom networks, being considered as a good option thanks to advantages such as fast time to market, low cost of installment, large capacities, and reliability. For most links the main limitation is rain which can cause signal fades as well as wind-induced mast sway, which apart from causing events with deep fading, might induce rapid fluctuations in the received signal power. This is particularly the case for links with large antenna gain and thus narrow beams, as such links are more sensitive to deviations from the optimal antenna alignment.

To be able to operate reliably even during the occurrence of fading events which cause the received signal power to drop, microwave links have the possibility of switching between a set of adaptive coding and modulation (ACM) states. An ACM state is defined by a modulation/constellation, a code rate and possibly also a bandwidth which together determine the capacity of data transmission. If a reduction in signal to noise ratio occurs such that reliable transmission at the ACM state with maximum capacity no longer is possible, a switch is made to a state with smaller capacity but requiring lower signal to noise ratio. When conditions go back to normal, the link can switch back to the state it was utilizing before the event. The switch back is typically done at a higher SNR value than the one at which the ACM reduction was made in order to avoid changes back and forth between ACM states which could result in bit-errors such that an ACM hysteresis is provided.

Switching between the ACM states is often based on a set of mean-square-error (MSE) thresholds reflecting the current signal to noise ratio, where the ACM state with the largest capacity among those with MSE threshold values higher than the current measured MSE of the demodulated signal is selected, since a smaller value of an MSE implies better performance.

The time between the detection of an MSE change and the change of the actual ACM state will always be connected with a certain time delay. The length of that time delay will be dependent on the actual system implementation, but if this time is longer than the time between the needed changes in ACM states, the system will not be able to adjust its ACM fast enough to be able to compensate for the change in MSE and bit errors will be generated in the detected signal. This could for instance happen in scenarios with strong and fast signal fades such as mast sway for microwave sites in strong wind.

It is therefore desired to provide improved functionality for providing a more robust and reliable handling of changes of transmission quality, for example measured as signal-to-noise ratio.

### SUMMARY

The object of the present disclosure is to provide a more robust and reliable handling of changes of transmission quality, for example measured as signal-to-noise ratio.

This object is obtained by means of a control unit arrangement adapted to control at least one communication setting between link nodes in a radio link arrangement comprising at least two link nodes that are adapted to communicate with each other via a time-dependent signal by means of the communication setting. For each time slot, the time-dependent signal is associated with at least a time-dependent communication quality and an identified transmission condition. The control unit arrangement comprising at least one adapting unit configured to adapt at least one threshold condition for switching from an original communication setting to an updated communication setting in dependence of an identified current transmission condition, such that each of the at least one threshold condition is changed from a first threshold condition to a second threshold condition.

This means that the communication setting can be adapted depending on a current transmission condition such that overall throughput can be maximized while still offering a low bit-error rate. This is for example advantageous when radio link arrangements often suffer from fast fading events, e.g. radio link arrangements deployed in unstable masts and/or in areas with strong multipath as well as in areas with quickly shifting weather conditions.

According to some aspects, the control unit arrangement further comprises at least one communication setting unit configured to switch from the original communication setting to the updated communication setting, the switching being performed based on at least the second threshold condition and a current time-dependent communication quality. According to some further aspects, the at least one communication setting unit is configured to switch from the original communication setting to the updated communication setting when the time-dependent communication quality passes the second threshold condition.

In this manner, the switching of communication setting can be adapted to other circumstances than only the time-dependent communication quality, and more specifically in dependence of what transmission condition that has been identified at a certain moment.

According to some aspects, each threshold condition comprises a corresponding hysteresis, such that each threshold condition is different in dependence of if the threshold condition is reached from an increasing communication quality or a decreasing communication quality. This further avoids unnecessary fluctuations between different communication settings.

According to some aspects, the control unit arrangement comprises a determining unit that is adapted to determine the time-dependent communication quality by means of signal data obtained from the time-dependent point-to-point signal when received at a link node in the form of least one of
attenuation;
received signal power,
a mean-squared error, MSE, value associated with data detection;
a power difference determined before and after channel filtering, associated with the radio link arrangement (100);
error vector magnitude;
bit error rate;
packet error rate; and/or
error seconds.

This means that the communication quality for example can be determined from signal data in the form of only MSE, such that the communication quality is the same as the signal data that is the. Alternatively, the communication quality can for example be determined from a plurality of different types of signal data such as for example attention, MSE and bit error rate, or even all the examples provided. This of course opens for a lot of alternatives, which is advantageous.

According to some aspects, the control unit arrangement comprises a classification unit that is adapted to provide at least one identified transmission condition by performing at least one of a quality parameter analysis of how the signal data changes over time; and/or a data analysis of acquired external data.

According to some aspects, the quality parameter analysis comprises at last one of transformation of sequences of time series data of received signal power, or signal attenuation, to the frequency domain by using the Fast Fourier Transform (FFT) and monitoring the power of frequency components representing rapid fluctuations known to require switching from the original communication setting to the updated communication setting, and/or monitoring fluctuations in time series data of an average of the received signal power or signal attenuation, and check if the rate of change exceeds a threshold.

This means that the quality parameter analysis can be made in many different ways such that different transmission condition can be identified in a versatile manner.

According to some aspects, the acquired external data comprises at last one of data from at least one temperature sensor arranged at least one link node, data from at least one motion sensor that is adapted to track antenna movement and orientation, and/or weather data provided by a remote server. This means that weather parameters can be obtained both locally and externally.

According to some aspects, the classification unit is adapted to run a learning state where different transmission conditions are identified. This means that the identification of different transmission conditions can be improved over time.

According to some aspects, the classification unit is adapted to store data used to identify transmission conditions. According to some further aspects, the classification unit is adapted to store data used to identify transmission conditions only when a presence of a transmission condition that differs from a normal state has been determined to occur.

This means that in order to avoid an unnecessary burden on the data storage, information may not be stored during normal operation of the point to point radio link arrangement. It can for example be chosen to only store data captured during wind events, and/or other types of events known to cause problems whose impact could be mitigated by means of the present disclosure

According to some aspects, the classification unit is adapted to associate each different identified transmission condition with a certain predetermined time constant that is a measure of how each specific identified transmission condition is considered to change over time.

Instead of only looking at the communication quality, the time constant of the transmission condition can also be considered. If the transmission condition has a slow time constant, such as rain, the threshold condition will be set accordingly, and may optionally have a smaller hysteresis than if the fading event has a fast time constant. This will result in higher margins, bit-error-free performance, but lower overall capacity during fading events with fast time variations and lower margins but higher overall capacity during fading events with slow time variations.

According to some aspects, the control unit arrangement comprises an acquiring unit that is adapted to acquire at least one identified transmission condition. This means that the acquiring unit can obtain at least one identified transmission condition from an external source, for example a remote server. This means that the dependence of local resources for obtaining identified transmission conditions is alleviated.

According to some aspects, at least one or more of the original communication setting and the updated communication setting is in the form of an adaptive coding and modulation, (ACM) state that is comprised in a set of at least two ACM states. According to some further aspects, an ACM state is defined by at least one of
a modulation/constellation,
a code rate, and
a bandwidth.

This means that standard parameters can be used to define communication settings, an ACM state is well-known in the art, and therefore suitable for the present disclosure.

According to some aspects, the control unit arrangement is adapted to determine the updated communication setting by using a multidimensional look-up table with different updated communication settings for different transmission conditions.

This means that the communication setting unit can be implemented as such a multidimensional look-up table, which constitutes an uncomplicated and reliable implementation. For example, if fluctuations in the signal power are detected that exceed a certain frequency and amplitude, the communication setting is selected from the table that have previously been found to work well in a certain transmission condition.

According to some aspects, the at least one adapting unit comprises a threshold optimizer unit that is adapted to determine the at least one threshold condition by maximizing both the time-dependent communication quality and a communicated data rate.

According to some aspects, the threshold optimizer unit is adapted to determine the at least one threshold condition by extracting parameters that, together with the communication quality and a currently used communication setting, are used to optimize the threshold condition depending on the type and characteristics of identified transmission conditions. The parameters include at least one of measures of how fast received signal power or signal attenuation changes with time, typical and maximum magnitude of fluctuations in the received signal power or link attenuation, and minimum received signal power during a certain transmission condition.

According to some aspects, the threshold optimizer unit is adapted to run a learning state where different threshold conditions are determined by relating different communication settings with different identified transmission conditions. This means that machine-learning can be used to find the optimum threshold level for each communication setting such that the threshold levels can be improved over time.

According to some aspects, the identified transmission conditions include, or correspond to, at least one of
a normal state,
wind,
rain,
snow,
obstruction from objects in a direct signal path,
multipath propagation,
selective fading,
interfering link nodes, and/or
temperature change.

This means that an identified transmission condition can be a parameter value that corresponds to the absence or presence of disturbances that affect microwave propagation, for example as listed above, or be a specifically identified condition, for example as listed above.

According to some aspects, the control unit arrangement is at least partly implemented as a control unit that is comprised in the radio link arrangement. In this way, an at least partly local control management is enabled.

According to some aspects, the control unit arrangement is at least partly implemented as a control unit that is comprised in a remote server. In this way, an at least partly remote control management is enabled, for example cloud-based.

This object is also obtained by means of a method for controlling a communication setting between link nodes in a radio link arrangement with at least two link nodes that are used for communicating with each other via a time-dependent signal by means of the communication setting. For each time slot, the time-dependent signal is associated with at least a time-dependent communication quality, and an identified transmission condition. The method comprises adapting at least one threshold condition for switching from an original communication setting to an updated communication setting in dependence of an identified current transmission condition, such that each of the at least one threshold condition is changed from a first threshold condition to a second threshold condition.

This means that the communication setting can be adapted depending on a current transmission condition such that overall throughput can be maximized while still offering a low bit-error rate. This is for example advantageous when radio link arrangements often suffer from fast fading events, e.g. radio link arrangements deployed in unstable masts and/or in areas with strong multipath as well as in areas with quickly shifting weather conditions.

Moreover, this object is also obtained by means of further method steps as set out in the dependent claims, a radio link arrangement, a computer program product comprising a computer program according to the methods described above, and a computer readable storage medium on which the computer program is stored. These are all associated with the above advantages.

### BRIEF DESCRIPTION OF THE DRAWINGS

The present disclosure will now be described more in detail with reference to the appended drawings, where:

FIGS. 1-2 show schematic views of point to point radio link arrangements;

FIG. 3 schematically illustrates a control unit arrangement according to some aspects of the present disclosure;

FIG. 4 schematically illustrates adapting threshold conditions;

FIG. 5 shows an example flowchart for a threshold optimizer unit;

FIG. 6-7 illustrate how link capacity varies with changing communication quality;

FIG. 8 shows flowcharts illustrating methods;

FIG. 9 schematically illustrates a computer program product; and

FIG. 10 illustrates a control unit arrangement according to some aspects of the present disclosure.

### DETAILED DESCRIPTION

Aspects of the present disclosure will now be described more fully with reference to the accompanying drawings. The different devices, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

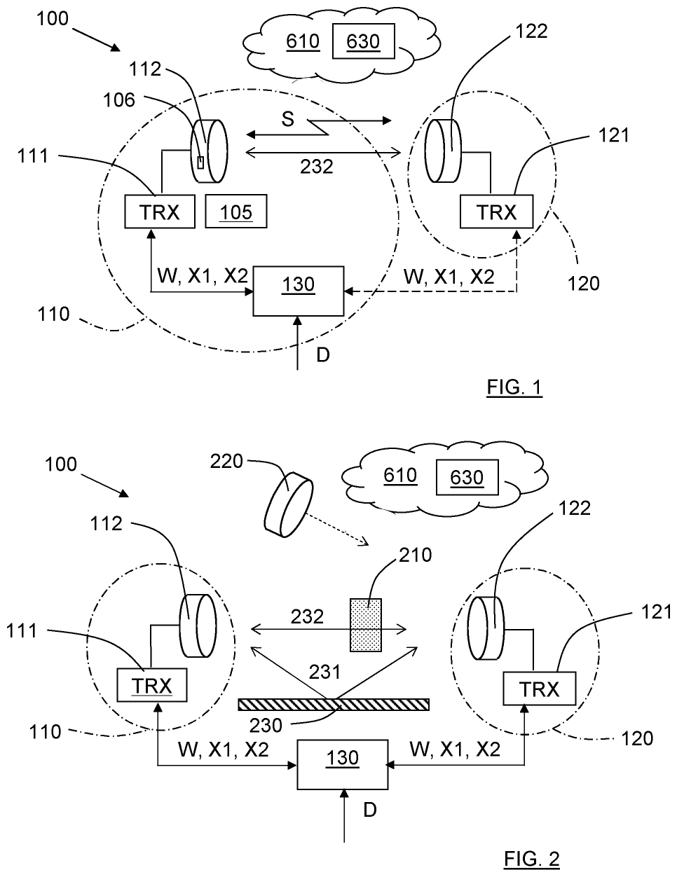

With reference to FIG. 1, there is a point to point radio link arrangement 100 comprising a first link node 110 and a second link node 120 which are arranged to communicate with each other. The first link node 110 comprises a first transceiver (TRX) 111 and a first antenna 112 and the second link node 120 comprises a second TRX 121 and a second antenna 122.

As illustrated in FIG. 2 which corresponds to FIG. 1, there is an interfering link node 220, an obstructing object 210 that obstructs a direct signal path 232 and for example can be in the form construction cranes, and an reflective object 230 that gives rise to multipath propagation 231 by means of reflections in addition to the direct signal path 232. These disturbances will be mentioned later.

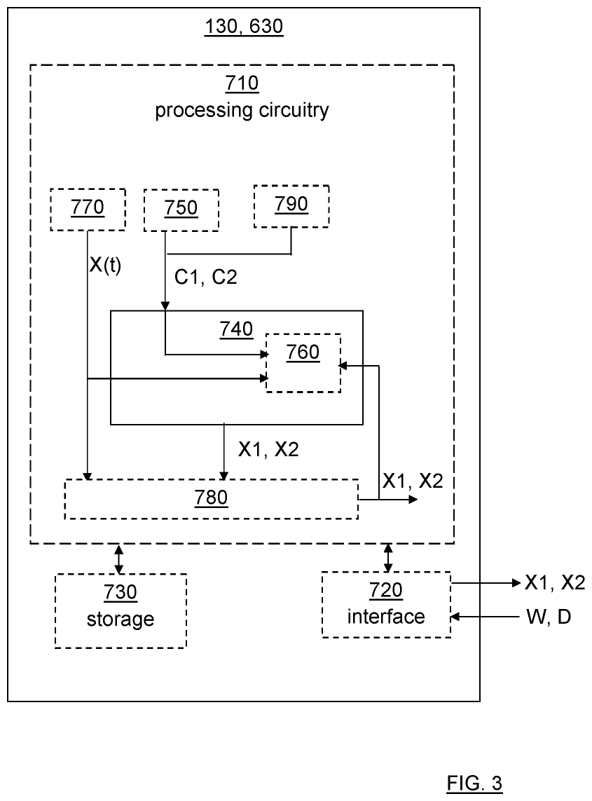

With reference also to FIG. 3, the point to point radio link arrangement 100 comprises a control unit arrangement 130 adapted to control at least one communication setting between the link nodes 110, 120 that are adapted to communicate with each other via a time-dependent point-to-point signal S by means of the communication setting. For each time slot, the time-dependent point-to-point signal S is associated with at least a time-dependent communication quality X(t) and an identified transmission condition C1, C2.

According to some aspects, the control unit arrangement 130 comprises a determining unit 770 that is adapted to determine the communication quality X(t) by means of signal data W obtained from the time-dependent point-to-point signal S when received at a link node 110, 120. The signal data W can for example comprise at least one of
attenuation;
received signal power,
a mean-squared error (MSE) value associated with data detection;
a power difference determined before and after channel filtering, associated with the point to point radio link arrangement 100;
error vector magnitude;
bit error rate;
packet error rate; and/or
error seconds.

The above are according to some aspect measures that are associated with how the time-dependent point-to-point signal S is affected when transferred from one link node 110 to another link node 120.

This means that the communication quality X(t) for example can be determined from signal data W in the form of only MSE, such that the communication quality X(t) is the same as the signal data W that is the MSE. Alternatively, the communication quality X(t) can for example be determined from a plurality of different types of signal data W such as for example attention, MSE and bit error rate, or even all the examples provided.

According to some aspects, determining unit 770 is adapted to provide the current time-dependent communication quality X(t2) in the form of a measure with a certain magnitude.

According to the present disclosure, the control unit arrangement 130 comprises at least one adapting unit 740 configured to adapt at least one threshold condition X1, X2 for switching from an original communication setting Y1 to an updated communication setting Y2 in dependence of an identified current transmission condition C2, such that each of the at least one threshold condition is changed from a first threshold condition X1 to a second threshold condition X2.

This means that the communication setting Y1, Y2 can be adapted depending on a current transmission condition C2 such that overall throughput can be maximized while still offering a low bit-error rate. The communication link arrangement does not need to be a point to point radio link arrangement 100, but can be a radio access link arrangement or any other type of wireless link arrangement. The present disclosure is for example suitable for radio link arrangements which can be expected to often suffer from fast fading events, e.g. radio link arrangements deployed in unstable masts and/or in areas with strong multipath as well as in areas with quickly shifting weather conditions. Correspondingly, the time-dependent point-to-point signal S can be any type of time-dependent signal S that is suitable for the wireless point to point radio link arrangement 100.

According to some aspects, such a communication setting Y1, Y2 can be in the form of an adaptive coding and modulation (ACM) state that is comprised in a set of at least two ACM states. As an example, an ACM state is defined by at least one of a modulation/constellation, a code rate, and a bandwidth. This means that standard parameters can be used to define communication settings, an ACM state is well-known in the art, and therefore suitable for the present disclosure.

According to some aspects, the control unit arrangement 130 further comprises at least one communication setting unit 780 configured to switch from the original communication setting Y1 to the updated communication setting Y2, the switching being performed based on at least the second threshold condition X2, input from the adapting unit 740, and a current time-dependent communication quality X(t2) that according to some aspects is input from the determining unit 770.

According to some further aspects, the communication setting unit 780 is configured to switch from the original communication setting Y1 to the updated communication setting Y2 when the time-dependent communication quality X(t) passes the updated threshold condition X2.

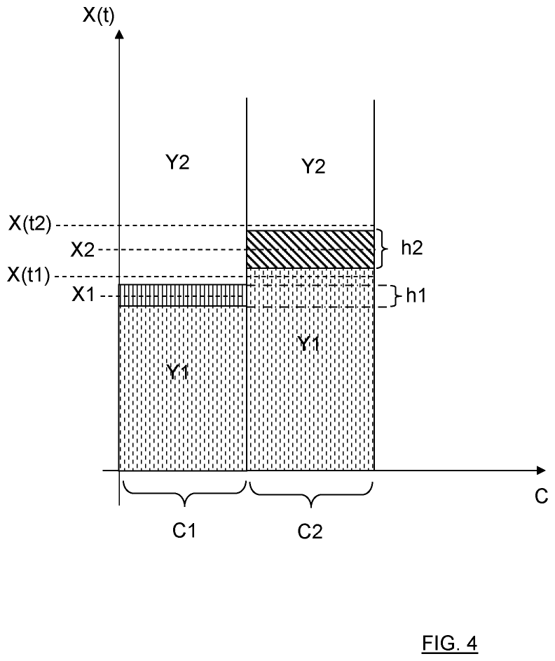

This is illustrated in FIG. 4, where the time-dependent communication quality X(t) runs along an y-axis and the transmission condition is indicated along an x-axis. While a previous identified transmission condition C1 is determined to be present, there is a first threshold condition X1 for switching from an original communication setting Y1, indicated with a pattern of vertical dashed lines, to an updated communication setting Y2, indicated without a pattern. When the time-dependent communication quality X(t) has a first value X(t1) that exceeds the first threshold condition X1, the updated communication setting Y2 is applied. The original communication setting Y1 is indicated with vertically running dashed lines, and the updated communication setting Y2 is indicated without any pattern.

When a current transmission condition C2 has been determined to be present, the first threshold condition X1 is changed to the second threshold condition X2, and now the first value X(t1) of the time-dependent communication quality X(t) falls below the second threshold condition X2 that now is in force, and this means that the original communication setting Y1 is applied. Not until the time-dependent communication quality X(t) exceeds the second threshold condition X2, for example by a second value X(t2), is the updated communication setting Y2 applied.

In this manner, the switching of communication setting can be adapted to other circumstances than only the time-dependent communication quality X(t), and more specifically in dependence of what transmission condition C1, C2 that has been identified at a certain moment. The transmission condition C1, C2 that has been identified at a certain moment may affect the time-dependent communication quality X(t), and can even be determined by means of the time-dependent communication quality X(t), but the dependent communication quality X(t) may also be more or less unaffected by the transmission condition C1, C2.

As an example of how to accomplish this, microwave link time series data, preferably samples of received signal power and/or link attenuation, are inserted into a the control unit arrangement 130 where the type of transmission condition C1, C2 that the point to point radio link arrangement currently experiences is identified. According to some aspects, the term transmission condition C1, C2 refers to the absence or presence of disturbances that affect microwave propagation, and could include, or correspond to, at least one of
a normal state, i.e. no disturbances
wind,
rain,
snow,
obstruction from objects 210 in a direct signal path 232,
multipath propagation 231,
selective fading,
interfering link nodes 220, and/or
temperature changes.

In for example a strong wind scenario, the time-dependent communication quality X(t) can fluctuate to a relatively large extent, that normally would lead to unnecessary fluctuations between different communication settings. The present disclosure enables more robust switching between different communication setting, avoiding unnecessary fluctuations.

In this context, generally, an identified transmission condition C1, C2 at least means that one or more parameters have been identified, where these parameters directly or indirectly are associated with the absence or presence of disturbances that affect microwave propagation, for example as listed above. In other words, an identified transmission condition does not need to explicitly specify conditions such as for example wind, rain or snow, but could at least be interpreted to represent such a condition. This can according to some aspects also mean This means that an identified transmission condition C1, C2 can be a parameter value that corresponds to the absence or presence of disturbances that affect microwave propagation, for example as listed above, or be a specifically identified condition, for example as listed above.

According to some aspect, link attenuation is a measure of how the signal power of the time-dependent point-to-point signal S is attenuated when transferred from one link node 110 to another link node 120, for example a difference between transmitted signal power at a transmitting link node and received signal power at a receiving link node.

According to some aspects, as shown in FIG. 4, each threshold condition X1, X2 comprises a corresponding hysteresis h1, h2, such that each threshold condition X1, X2 is different in dependence of if the threshold condition X1, X2 is reached from an increasing communication quality X(t) or a decreasing communication quality X(t). This further avoids unnecessary fluctuations between different communication settings. The first hysteresis h1 is indicated with a pattern of vertical lines, and the second hysteresis h2 is indicated with a pattern of inclined lines.

According to some aspects, the control unit arrangement 130 is adapted to determine the updated communication setting Y2 by using a multidimensional look-up table with different updated communication settings for different transmission conditions C1, C2. This means that the communication setting unit 780 can be implemented as such a multidimensional look-up table. For example, if fluctuations in the signal power are detected that exceed a certain frequency and amplitude, the communication setting is selected from the table that have previously been found to work well in a certain transmission condition C1, C2.

According to some aspects, the control unit arrangement 130 is adapted to associate each different identified transmission condition C1, C2 with a certain predetermined time constant that is a measure of how each specific identified transmission condition C1, C2 is considered to change over time.

Instead of only looking at the communication quality X(t), the time constant of the transmission condition C1, C2 will then also be considered. If the transmission condition C1, C2 has a slow time constant, such as rain, the threshold condition X1, X2 will be set accordingly, and may have a smaller hysteresis than if the fading event has a fast time constant. This will result in higher margins, bit-error-free performance, but lower overall capacity during fading events with fast time variations and lower margins but higher overall capacity during fading events with slow time variations.

The present disclosure confers a possibility to detect and identify different transmission conditions C1, C2 where this information can be used in combination with the communication quality X(t) for obtaining an optimal communication setting Y1, Y2 and possible hysteresis h1, h2 from a performance perspective.

In for example a strong wind scenario, the control unit arrangement 130 is adapted to switch to a more robust communication setting for as long as necessary, and the choice should, when possible, be based on statistics on how the link node in question and/or other link nodes have performed previously in similar situations. It is therefore, according to aspects, suitable to collect statistics during problematic events associated with different transmission conditions C1, C2 such that the system can learn which communication setting Y1, Y2 to use in different circumstances. According to some aspects, the necessary algorithms are implemented such that the solution relies on information in the link nodes 110, 120 themselves which would minimize latency and facilitate utilizing high sampling rates, but training of models and statistics collection could also occur at a central location such as an external, or remote, server 610.

In the following, determining threshold conditions and identifying transmission conditions will be discussed, where both these can be subject to machine-learning.

According to some aspects, the control unit arrangement 130 comprises a threshold optimizer unit 760 that is adapted to determine at least one threshold condition X1, X2 by maximizing both communication quality X(t) and a communicated data rate, i.e. a rate at which data is transferred. According to some aspects, the threshold optimizer unit 760 is adapted to determine at least one threshold condition X1, X2 by extracting parameters that, together with the communication quality X(t) and a currently used communication setting Y1, Y2, are used to optimize the threshold condition X1, X2 depending on the type and characteristics of identified transmission conditions C1, C2. The parameters include at least one of
measures of how fast received signal power or link attenuation changes with time,
typical and maximum magnitude of fluctuations in the received signal power or the link attenuation, and
minimum received signal power during a certain transmission condition C1, C2.

For example, threshold optimizer unit 760 is adapted to try to find the optimum threshold level for each communication setting Y1, Y2 by minimizing the bit-error rate, or other suitable performance metrics such as error seconds, packet loss, etc, while maximizing the overall throughput. This can for example be implemented by means of an optimization algorithm minimizing a cost function. The data fed into the threshold optimizer unit 760 may be stored in a statistics database which could be internal in the link node 110, 120, or external. In case an external database is used it can for example be a cloud-based solution, for example using a remote server 610.

In this manner, the threshold conditions X1, X2 can be determined in an optimal manner.

According to some aspects, the threshold optimizer unit 760 is adapted to run a learning state where different threshold conditions X1, X2 are determined by relating different communication settings Y1, Y2 with different identified transmission conditions C1, C2. This means that machine-learning can be used to find the optimum threshold level for each communication setting Y1, Y2 such that the threshold levels can be improved over time.

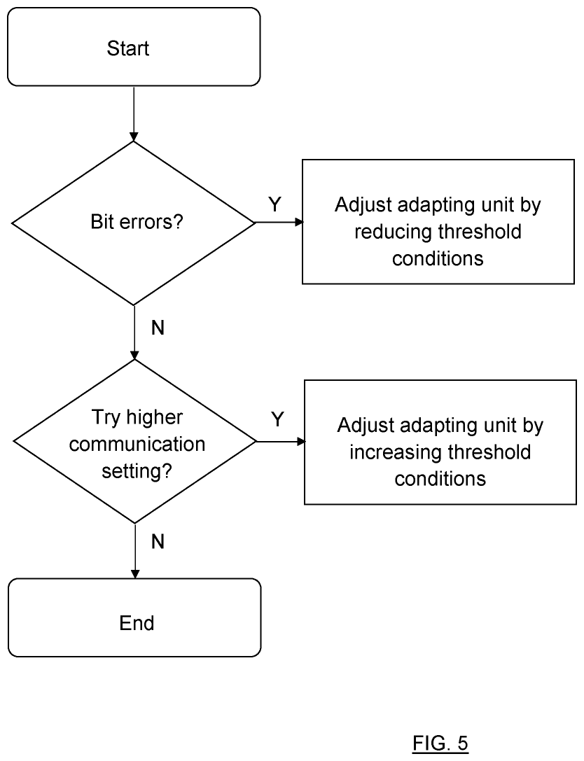

FIG. 5 discloses a simplified flowchart that illustrate some aspects of the present disclosure, in particular for a threshold optimizer unit 760. After a process start, it is determined if there are bit errors present in a received signal. If that is the case, the adapting unit 740 is adjusted to reduce the threshold conditions. If not, it is determined if a higher communications setting should be applied. If that is the case, the adapting unit 740 is adjusted to increase the threshold conditions.

According to some aspects, the control unit arrangement 130 comprises a classification unit 750 that is adapted to provide at least one identified transmission condition C1, C2 by performing at least one of a quality parameter analysis of how the signal data W changes over time, and/or a data analysis of acquired external data D.

According to some aspects, the quality parameter analysis comprises at last one of:
transformation of sequences of time series data of received signal power, or signal attenuation, to the frequency domain by using the Fast Fourier Transform (FFT) and monitoring the power of frequency components representing rapid fluctuations known to require switching from the first communication setting to the second communication setting, and/or
monitoring fluctuations in time series data of the average received signal power or signal attenuation, and check if the rate of change exceeds a threshold.

This means that the quality parameter analysis can be made in many different ways such that different transmission condition can be identified in a versatile manner.

According to some aspects, the acquired external data comprises at last one of data from at least one temperature sensor 105 arranged at at least one link node, data from at least one motion sensor that is adapted to track antenna movement and orientation, and/or weather data provided by a remote server. That means that weather parameters can be obtained locally and externally.

According to some aspects, the control unit arrangement 130 comprises an acquiring unit 790 that is adapted to acquire the at least one identified transmission condition C1, C2. This means that the acquiring unit 790 can obtain at least one identified transmission condition C1, C2 from an external source, for example a remote server 610. This means that the dependence of local resources for obtaining identified transmission conditions is alleviated. The control unit arrangement 130 can comprise either a classification unit 750 or an acquiring unit 790, or alternatively, the control unit arrangement 130 can comprise both a classification unit 750 and an acquiring unit 790 that work in parallel.

According to some aspects, the classification unit 750 is adapted to run a learning state where different transmission conditions C1, C2 are identified. This means that the identification of different transmission conditions can be improved over time.

The control unit arrangement 130 can be adapted to identify transmission conditions C1, C2 with different methods. According to some aspects, as mentioned above, machine learning algorithms can be utilized and trained beforehand using data captured during different conditions or updated during the lifetime of the product as more data representing different types of events is captured. This means that the control unit arrangement 130 is adapted to collect statistics during problematic events that correspond to different transmission conditions C1, C2 such that the control unit arrangement 130 gradually can learn which communication setting Y1, Y2 to use in different circumstances. According to some aspects, the algorithms can be implemented such that the solution relies on information in the link nodes 110, 120 themselves as this would minimize latency and facilitate utilizing high sampling rates, but training of models and statistics collection could also occur at a central location such as a remote server 610.

According to some aspects, the classification unit 750 is adapted to store data used to identify transmission conditions C1, C2. According to further some aspects, the classification unit 750 is adapted to store data used to identifying transmission conditions C1, C2 only when a presence of a transmission condition C1, C2 that differs from a normal state has been determined to occur.

This means that in order to avoid an unnecessary burden on the data storage, information will not be stored during normal operation of the point to point radio link arrangement 100. It can for example be chosen to only store data captured during wind events, and/or other types of events known to cause problems whose impact could be mitigated by means of the present disclosure. A statistics database could either be internal in each link node 110, 120, or external. It could also be a combination of both, in which case event information is stored for all link nodes in a central location such as a remote server 610 or in a distributed manner where the link nodes in the point to point radio link arrangement 100 are split into subsets that share one database each. Data in the statistics database can be used to retrain and thereby improve the algorithms used for identifying transmission conditions C1, C2 as well as the communication setting unit 780. After an improved model has been trained, the model can be distributed to the link nodes 110, 120 from the location where it was created.

Using a shared database implies that each link node 11, 120 has access to information useful for obtaining each communication setting Y1, Y2 optimally. Suitably, the threshold optimizer unit 760 is provided externally, for example at a remote server 610, to ease the computational burden for the point to point radio link arrangement 100.

According to some aspects, the classification unit 750 is adapted to associate each different identified transmission condition C1, C2 with the certain predetermined time constant.

According to some aspects the control unit arrangement 130, 630 is at least partly implemented as a control unit 130 that is comprised in the point to point radio link arrangement 100. In this way, an at least partly local control management is enabled.

According to some aspects the control unit arrangement 130, 630 is at least partly implemented as a control unit 630 that is comprised in a remote server 610. In this way, an at least partly remote control management is enabled, for example cloud-based.

This means that the units 740 750, 760, 770, 780, 790 that are described to be comprised in the control unit arrangement can be comprised in one control unit 130, 630 only, or distributed and comprised in different control units 130, 630.

It is to be understood that for reasons of illustrating the present disclosure in an uncomplicated manner, only two threshold condition X1, X2 and only two communication settings Y1, Y2 are illustrated in FIG. 4. Practically, there can be more threshold conditions and more communication settings.

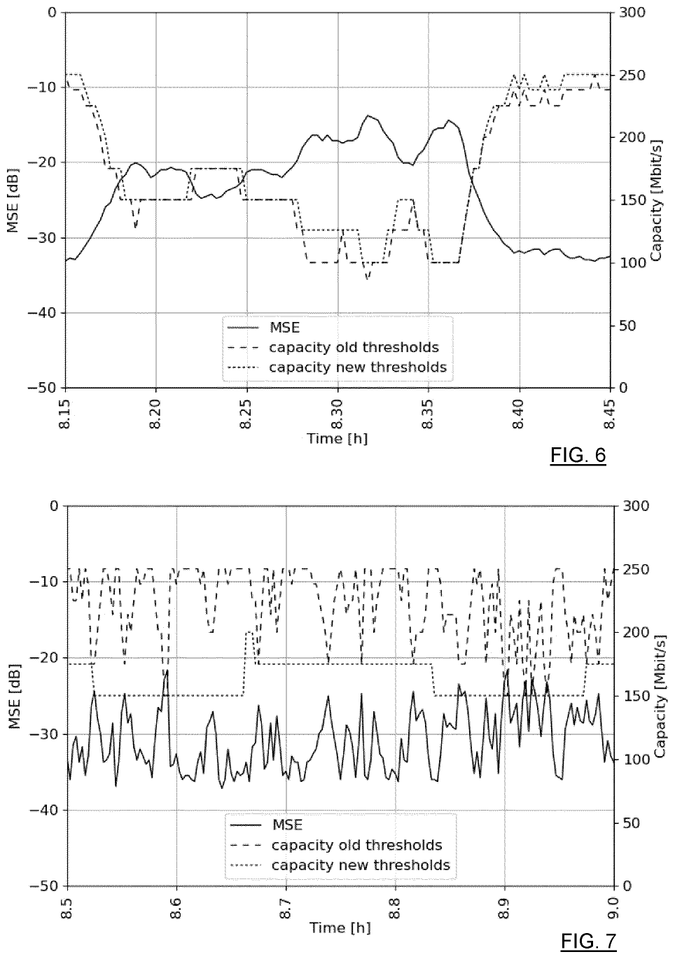

FIG. 6 shows an example where the point to point radio link arrangement 100 is affected by rain, and illustrates how the capacity varies over time versus the time-dependent communication quality X(t) in the form of MSE, both for the case with fixed threshold conditions as indicated with dashed lines and with variable threshold conditions according to the present disclosure as indicated with dotted lines.

FIG. 7 shows an example where the point to point radio link arrangement 100 is affected by wind, and illustrates how the capacity varies over time versus the time-dependent communication quality X(t) in the form of MSE, both for the case with fixed threshold conditions as indicated with dashed lines and with variable threshold conditions according to the present disclosure as indicated with dotted lines.

With reference to FIG. 1, according to some aspects, the link nodes 110, 120 send information, e.g., transmission condition data, communication setting data and performance data, to a central processing hub such as a remote server 610 which collects statistics from the link nodes 110, 120 and trains new improved models for transmission condition identification/characterization and communication setting selection. New models are pushed by the remote server 610 to the link nodes 110, 120.

Alternatively, according to some further aspects, the central remote server 610 itself performs the transmission condition identification/characterization. In case a link node 110, 120 suffers from a problematic operating condition, the remote server 610 can send instructions to the link nodes 110, 120 about the maximum communication setting state to use. This decision can be updated depending on the severity of the operating conditions. E.g. if a wind event is ongoing which only causes a small variation in the link attenuation, it might be ok to use the communication setting with the highest capacity, etc.

According to some aspects, there is a control unit arrangement 130, 630 adapted to control at least one communication setting between link nodes in a point to point radio link arrangement 100 comprising at least two link nodes 110, 120 that are adapted to communicate with each other via a time-dependent point-to-point signal S by means of the communication setting. For each time slot, the time-dependent point-to point signal S is associated with at least a time-dependent communication quality X(t) and an identified transmission condition C1, C2. The control unit arrangement 130, 630 comprises at least one communication setting unit 780 that is configured to switch from an original communication setting Y1 to an updated communication setting Y2, the switching being performed based on at least an identified current transmission condition C2 and a current time-dependent communication quality X(t2).

According to some further aspects, the control unit arrangement 130, 630 further comprises at least one adapting unit 740, configured to adapt at least one threshold condition X1, X2 for switching from the original communication setting Y1 to the updated communication setting Y2, such that the threshold condition is changed from a first threshold condition X1 to a second threshold condition X2, in dependence of the identified current transmission condition C2. The communication setting unit 780 is configured to switch from the original communication setting Y1 to the updated communication setting Y2 based on at least the second threshold condition X2 and the determined current time-dependent communication quality X(t2).

According to some aspects, the feature that the switching being performed based on at least an identified current transmission condition C2 and a current time-dependent communication quality X(t2) implicitly means that the switching is performed based on at least the second threshold condition X2.

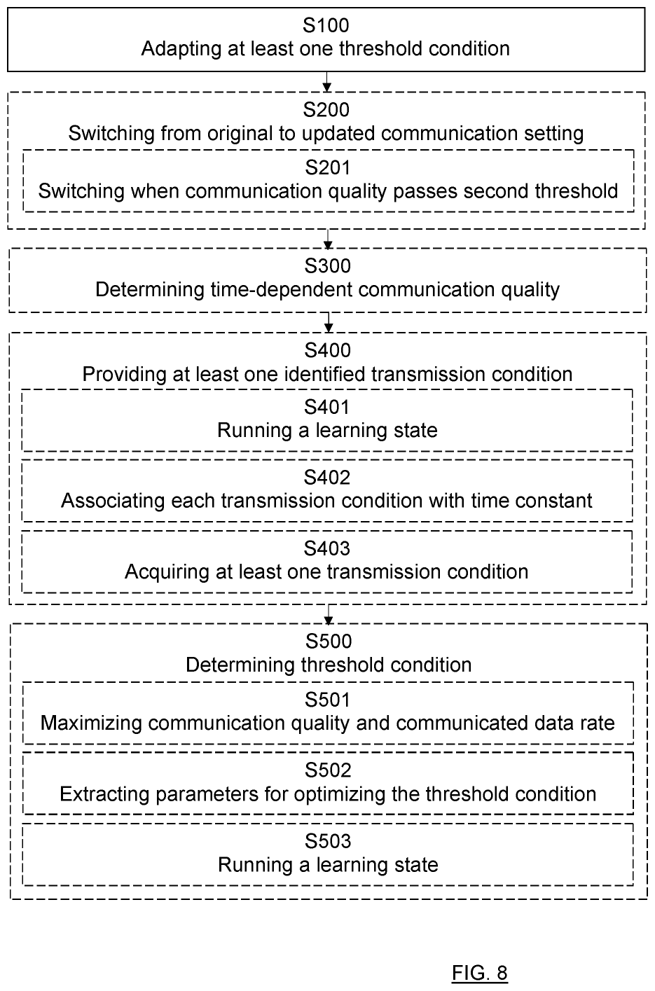

With reference to FIG. 8, the present disclosure relates to a method for controlling a communication setting between link nodes 110, 120 in a radio link arrangement 100 with at least two link nodes 110, 120 that are used for communicating with each other via a time-dependent signal S by means of the communication setting. For each time slot, the time-dependent signal S is associated with at least a time-dependent communication quality X(t), and an identified transmission condition C1, C2.

The method comprises adapting S100 at least one threshold condition X1, X2 for switching from an original communication setting Y1 to an updated communication setting Y2 in dependence of an identified current transmission condition C2, such that each of the at least one threshold condition is changed from a first threshold condition X1 to a second threshold condition X2.

According to some aspects, the method further comprises switching S200 from the original communication setting Y1 to the updated communication setting Y2 based on at least the second threshold condition X2 and a current time-dependent communication quality X(t2).

According to some aspects, the method comprises switching S201 from the original communication setting Y1 to the updated communication setting Y2 when the time-dependent communication quality X(t) passes the second threshold condition X2.

According to some aspects, the method comprises providing a corresponding hysteresis h1, h2 for each threshold condition X1, X2, such that each threshold condition X1, X2 is different in dependence of if the threshold condition X1, X2 is reached from an increasing communication quality X(t) or a decreasing communication quality X(t).

According to some aspects, the method comprises determining S300 the time-dependent communication quality X(t) by means of signal data W obtained from the time-dependent point-to-point signal S when received at a link node 110, 120 in the form of least one of
attenuation;
received signal power,
a mean-squared error (MSE) value associated with data detection;
a power difference determined before and after channel filtering, associated with the radio link arrangement 100;
error vector magnitude;
bit error rate;
packet error rate; and/or
error seconds.

According to some aspects, the method comprises providing S400 at least one identified transmission condition C1, C2 by performing at least one of a quality parameter analysis of how the signal data W changes over time, and/or a data analysis of acquired external data D.

According to some aspects, the quality parameter analysis comprises at last one of transformation of sequences of time series data of received signal power, or signal attenuation, to the frequency domain by using the Fast Fourier Transform FFT and monitoring the power of frequency components representing rapid fluctuations known to require switching from the original communication setting Y1 to the updated communication setting Y2, and/or monitoring fluctuations in time series data of an average of the received signal power or signal attenuation, and check if the rate of change exceeds a threshold. According to some aspects, the acquired external data D comprises at last one of data from at least one temperature sensor 105 arranged at least one link node 110,120, data from at least one motion sensor 106 that is adapted to track antenna movement and orientation, and/or weather data provided by a remote server 610.

According to some aspects, the method comprises storing data used to identify transmission conditions C1, C2.

According to some aspects, the method comprises storing data used to identify transmission conditions C1, C2 only when a presence of a transmission condition C1, C2 that differs from a normal state has been determined to occur.

According to some aspects, the method comprises running S401 a learning state where different transmission conditions C1, C2 are identified.

According to some aspects, the method comprises associating S402 each different identified transmission condition C1, C2 with a certain predetermined time constant that is a measure of how each specific identified transmission condition C1, C2 is considered to change over time.

According to some aspects, the method comprises acquiring S403 at least one identified transmission condition C1, C2.

According to some aspects, at least one or more of the original communication setting Y1 and the updated communication setting Y2 is in the form of an adaptive coding and modulation, ACM, state that is comprised in a set of at least two ACM states.

According to some aspects, an ACM state is defined by at least one of
a modulation/constellation,
a code rate, and
a bandwidth.

According to some aspects, the method comprises determining the updated communication setting Y2 by using a multidimensional look-up table with different updated communication settings for different transmission conditions C1, C2.

According to some aspects, the method comprises determining S500 the at least one threshold condition X1, X2 by maximizing S501 both the time-dependent communication quality X(t) and a communicated data rate.

According to some aspects, the method comprises determining S500 the at least one threshold condition X1, X2 by extracting S502 parameters that, together with the communication quality X(t) and a currently used communication setting Y1, Y2, are used to optimize the threshold condition X1, X2 depending on the type and characteristics of identified transmission conditions C1, C2.

The parameters include at least one of measures of how fast received signal power or signal attenuation changes with time, typical and maximum magnitude of fluctuations in the received signal power or link attenuation, and minimum received signal power during a certain transmission condition C1, C2.

According to some aspects, the method comprises running S503 a learning state where different threshold conditions X1, X2 are determined by relating different communication settings Y1, Y2 with different identified transmission conditions C1, C2.

According to some aspects, the identified transmission conditions C1, C2 include, or correspond to, at least one of
a normal state,
wind,
rain,
snow,
obstruction from objects 210 in a direct signal path 232,
multipath propagation 231,
selective fading,
interfering link nodes 220, and/or
temperature change.

According to some aspects, a control unit 130, used in the radio link arrangement 100, is used for at least partly performing the method.

According to some aspects, a control unit 630, used in at least one remote server 610, is used for at least partly performing the method.

Furthermore, with renewed reference to FIG. 3, there is illustrated the control unit arrangement 130, 630 according to aspects of the present disclosure. It is appreciated that the above described methods and techniques may be realized in hardware. This hardware is then arranged to perform the methods, whereby the same advantages and effects are obtained as have been discussed above.

Processing circuitry 710 is provided using any combination of one or more of a suitable central processing unit (CPU), multiprocessor, microcontroller, digital signal processor (DSP), etc., capable of executing software instructions stored in a computer program product, e.g. in the form of a storage medium 730. The processing circuitry 710 may further be provided as at least one application specific integrated circuit (ASIC), or field programmable gate array (FPGA). The storage medium 730 may comprise storage for other data collected and produced for the present disclosure, such as for example statistical data and machine-learning models

Particularly, the processing circuitry 710 is configured to cause the classification unit to perform a set of operations, or steps. For example, the storage medium 730 may store the set of operations, and the processing circuitry 710 may be configured to retrieve the set of operations from the storage medium 730 to cause the classification unit to perform the set of operations. The set of operations may be provided as a set of executable instructions. Thus, the processing circuitry 710 is thereby arranged to execute methods as herein disclosed.

The storage medium 730 may also comprise persistent storage, which, for example, can be any single one or combination of magnetic memory, optical memory, solid state memory or even remotely mounted memory.

The classification unit may further comprise a communication interface 720 for communications with at least one external device. As such the communication interface 720 may comprise one or more transmitters and receivers, comprising analogue and digital components and a suitable number ports for wireline or wireless communication. The communication interface 720 can for example be adapted to input signal data S and acquired external data D, as well as to output threshold conditions X1, X2.

The processing circuitry 710 controls the general operation of the unit, e.g. by sending data and control signals to the communication interface 720 and the storage medium 730, by receiving data and reports from the communication interface 720, and by retrieving data and instructions from the storage medium 730. Other components, as well as the related functionality, of the unit are omitted in order not to obscure the concepts presented herein.

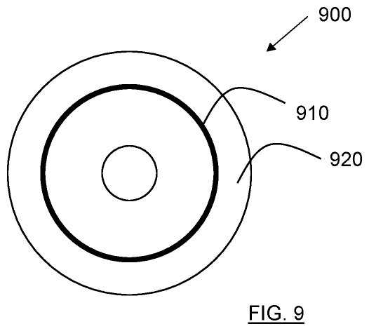

FIG. 9 schematically illustrates a computer program product 900 comprising a computer program 910 for adapting communication between link nodes in a point to point radio link arrangement 100, and a computer readable storage medium 920 on which the computer program 910 is stored.

The present disclosure also relates to the computer program 910 for controlling a communication setting between link nodes in a radio link arrangement 100 comprising at least two link nodes 110, 120 that are adapted to communicate with each other via a time-dependent signal S by means of the communication setting. For each time slot, the time-dependent signal S is associated with at least:
a time-dependent communication quality X(t); and
an identified transmission condition C1, C2.

The computer program 910 comprises computer code which, when run on processing circuitry 710 of a control unit arrangement 130, causes the control unit arrangement 130 to adapt at least one threshold condition X1, X2 for switching from an original communication setting Y1 to an updated communication setting Y2 in dependence of an identified current transmission condition C2, such that each of the at least one threshold condition is changed from a first threshold condition X1 to a second threshold condition X2.

The present disclosure is not limited to the above, but may vary freely within the scope of the appended claims. For example, each one of the point to point radio links can be any form of point to point radio links such as for example microwave links.

According to some aspects, a point to point radio link may be comprised in a point to point radio link network that in turn can comprise more than one point to point radio link, and thus more than two point to point radio link transceivers.

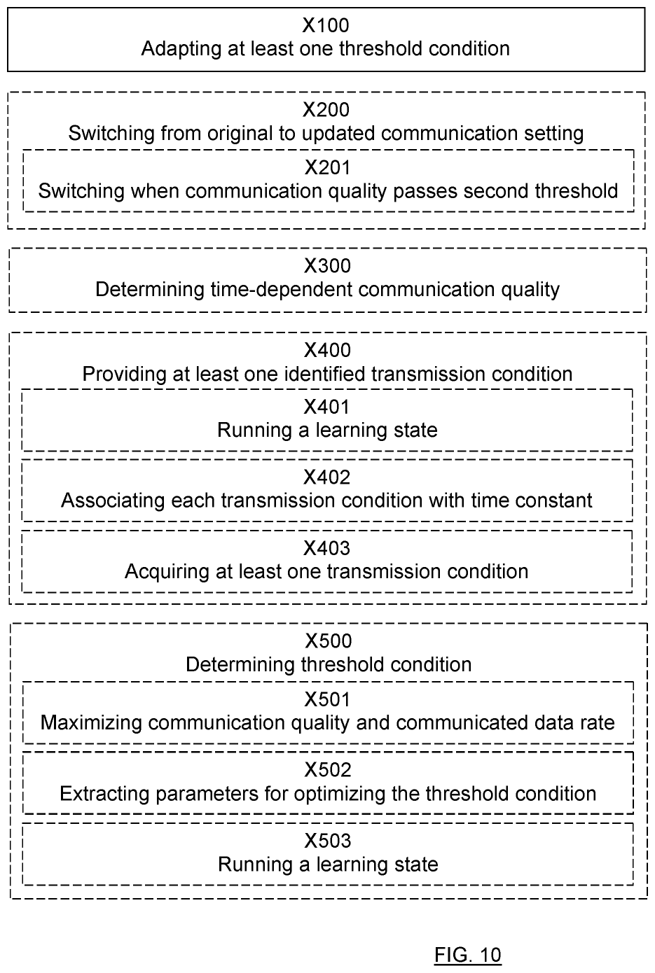

FIG. 10 illustrates a control unit arrangement for controlling a communication setting between link nodes 110, 120 in a radio link arrangement 100 with at least two link nodes 110, 120 that are used for communicating with each other via a time-dependent signal S by means of the communication setting. For each time slot, the time-dependent signal S is associated with at least a time-dependent communication quality X(t), and an identified transmission condition C1, C2.

The control unit arrangement comprises an adapting unit X100 that is configured to adapt at least one threshold condition X1, X2 for switching from an original communication setting Y1 to an updated communication setting Y2 in dependence of an identified current transmission condition C2, such that each of the at least one threshold condition is changed from a first threshold condition X1 to a second threshold condition X2. According to some aspects, the adapting unit X100 corresponds to the adapting unit 740 described previously.

According to some aspects, the control unit arrangement further comprises a first switching unit X200 that is configured to switch from the original communication setting Y1 to the updated communication setting Y2 based on at least the second threshold condition X2 and a current time-dependent communication quality X(t2). According to some aspects, the first switching unit X200 corresponds to the communication setting unit 780 described previously.

According to some aspects, the control unit arrangement further comprises a second switching unit X201 that is configured to switch from the original communication setting Y1 to the updated communication setting Y2 when the time-dependent communication quality X(t) passes the second threshold condition X2. According to some aspects, the second switching unit X201 corresponds to the communication setting unit 780 described previously.

According to some aspects, the control unit arrangement further comprises a first determining unit X300 that is configured to determine the time-dependent communication quality X(t) by means of signal data W obtained from the time-dependent point-to-point signal S when received at a link node 110, 120 in the form of least one of
attenuation;
received signal power,
a mean-squared error (MSE) value associated with data detection;
a power difference determined before and after channel filtering, associated with the radio link arrangement 100;
error vector magnitude;
bit error rate;
packet error rate; and/or
error seconds.

According to some aspects, the first determining unit X300 corresponds to the determining unit 770 described previously.

According to some aspects, the control unit arrangement further comprises a providing unit X400 that is configured to provide at least one identified transmission condition C1, C2 by performing at least one of a quality parameter analysis of how the signal data W changes over time, and/or a data analysis of acquired external data D. According to some aspects, the providing unit X400 corresponds to the classification unit 750 described previously.

According to some aspects, the control unit arrangement further comprises a first running unit X401 that is configured to run a learning state where different transmission conditions C1, C2 are identified. According to some aspects, the running unit X401 corresponds to the classification unit 750 described previously.

According to some aspects, the control unit arrangement further comprises an associating unit X402 that is configured to associate each different identified transmission condition C1, C2 with a certain predetermined time constant that is a measure of how each specific identified transmission condition C1, C2 is considered to change over time. According to some aspects, the associating unit X402 corresponds to the classification unit 750 described previously.

According to some aspects, the control unit arrangement further comprises an acquiring unit X403 that is configured to acquire at least one identified transmission condition C1, C2. According to some aspects, the acquiring unit X403 corresponds to the acquiring unit 790 described previously.

According to some aspects, the control unit arrangement further comprises a second determining unit X500 and a maximizing unit X501, where the second determining unit X500 is configured to determine the at least one threshold condition X1, X2 by using the maximizing unit X501 that is configured to maximize both the time-dependent communication quality X(t) and a communicated data rate.

According to some aspects, the control unit arrangement further comprises an extracting unit X502, where the second determining unit X500 is configured to determine the at least one threshold condition X1, X2 by using the extracting unit X502 that is configured to extract parameters that, together with the communication quality X(t) and a currently used communication setting Y1, Y2, are used to optimize the threshold condition X1, X2 depending on the type and characteristics of identified transmission conditions C1, C2.

According to some aspects, the control unit arrangement further comprises a second running unit X503 that is configured to run a learning state where different threshold conditions X1, X2 are determined by relating different communication settings Y1, Y2 with different identified transmission conditions C1, C2.

According to some aspects, at least one of the second determining unit X500, the maximizing unit X501, the extracting unit X502 and the second running unit X503 corresponds to the threshold optimizer unit 760 described previously.

1. A control unit arrangement adapted to control at least one communication setting between link nodes in a radio link arrangement comprising at least two link nodes that are adapted to communicate with each other via a time-dependent signal by means of the communication setting, wherein, for each time slot, the time-dependent signal is associated with at least:
a time-dependent communication quality; and
an identified transmission condition;
the control unit arrangement comprising at least one adapting unit configured to:
adapt at least one threshold condition for switching from an original communication setting to an updated communication setting based on an identified current transmission condition, such that each of the at least one threshold condition is changed from a first threshold condition to a second threshold condition.

2. The control unit arrangement of claim 1, wherein the control unit arrangement further comprises;
at least one communication setting unit configured to switch from the original communication setting to the updated communication setting, the switching being performed based on at least the second threshold condition and a current time-dependent communication quality.

3. The control unit arrangement of claim 2, wherein the at least one communication setting unit is configured to switch from the original communication setting to the updated communication setting when the time-dependent communication quality passes the second threshold condition.

4. The control unit arrangement of claim 1, wherein each threshold condition comprises a corresponding hysteresis, such that each threshold condition is different in dependence of if the threshold condition is reached from an increasing communication quality or a decreasing communication quality.

5. The control unit arrangement of claim 1, wherein the control unit arrangement comprises a determining unit that is adapted to determine the time-dependent communication quality by means of signal data obtained from the time-dependent point-to-point signal when received at a link node in the form of least one of
attenuation;
received signal power;
a mean-squared error, MSE, value associated with data detection;
a power difference determined before and after channel filtering, associated with the radio link arrangement;
error vector magnitude;
bit error rate;
packet error rate; and/or
error seconds.

6. The control unit arrangement of claim 5, wherein the control unit arrangement comprises a classification unit that is adapted to provide at least one identified transmission condition by performing at least one of
a quality parameter analysis of how the signal data changes over time; and/or
a data analysis of acquired external data.

7. The control unit arrangement of claim 6, wherein the quality parameter analysis comprises at last one of:
transformation of sequences of time series data of received signal power, or signal attenuation, to the frequency domain by using the Fast Fourier Transform (FFT), and monitoring the power of frequency components representing rapid fluctuations known to require switching from the original communication setting to the updated communication setting, and/or
monitoring fluctuations in time series data of an average of the received signal power or signal attenuation, and check if the rate of change exceeds a threshold.

8. The control unit arrangement of claim 6, wherein the acquired external data comprises at last one of:
data from at least one temperature sensor arranged at least one link node;
data from at least one motion sensor that is adapted to track antenna movement and orientation, and/or
weather data provided by a remote server.

9. The control unit arrangement of claim 6, wherein the classification unit is adapted to store data used to identify transmission conditions.

10. The control unit arrangement of claim 6, wherein the classification unit is adapted to store data used to identify transmission conditions only when a presence of a transmission condition that differs from a normal state has been determined to occur.

11. The control unit arrangement of claim 6, wherein the classification unit is adapted to run a learning state where different transmission conditions are identified.

12. The control unit arrangement of claim 6, wherein the classification unit is adapted to associate each different identified transmission condition with a certain predetermined time constant that is a measure of how each specific identified transmission condition is considered to change over time.

13. The control unit arrangement of claim 1, wherein the control unit arrangement comprises an acquiring unit that is adapted to acquire at least one identified transmission condition.

14. The control unit arrangement of claim 1, wherein at least one or more of the original communication setting and the updated communication setting is in the form of an adaptive coding and modulation, ACM, state that is comprised in a set of at least two ACM states.

15. The control unit arrangement of claim 1, wherein an ACM state is defined by at least one of
a modulation/constellation,
a code rate, and
a bandwidth.

16. The control unit arrangement of claim 1, wherein the control unit arrangement is adapted to determine the updated communication setting by using a multidimensional look-up table with different updated communication settings for different transmission conditions.

17. The control unit arrangement of claim 1, wherein the at least one adapting unit comprises a threshold optimizer unit that is adapted to determine the at least one threshold condition by maximizing both the time-dependent communication quality and a communicated data rate.

18-20. (canceled)

21. The control unit arrangement of claim 1, wherein the control unit arrangement at least partly is implemented as a control unit that is comprised in the radio link arrangement.

22. The control unit arrangement of claim 1, wherein the control unit arrangement at least partly is implemented as a control unit that is comprised in a remote server.

23. A method for controlling a communication setting between link nodes in a radio link arrangement with at least two link nodes that are used for communicating with each other via a time-dependent signal by means of the communication setting, the time-dependent signal, for each time slot, being associated with at least:
a time-dependent communication quality; and
an identified transmission condition;
where the method comprises
adapting at least one threshold condition for switching from an original communication setting to an updated communication setting in dependence of an identified current transmission condition, such that each of the at least one threshold condition is changed from a first threshold condition to a second threshold condition.

24-47. (canceled)
